(19) United States
(12) Patent Application Publication
(10) Pub. No.: US 2021/0140388 A1
(43) Pub. Date: May 13, 2021

(54) Fuel Injection Control Device

(71) Applicant: Hitachi Automotive Systems, Ltd., HItachinaka-shi, Ibaraki (JP)

(72) Inventors: Ryo KUSAKABE, Tokyo (JP); Yoshihiro SUKEGAWA, Tokyo (JP); Kenichiroh OGATA, Tokyo (JP); Masayuki SARUWATARI, Tokyo (JP)

(21) Appl. No.: 16/617,375

(22) PCT Filed: May 11, 2018
(86) PCT No.: PCT/JP2018/018258

§ 371 Date: Nov. 26, 2019

(30) Foreign Application Priority Data
May 31, 2017 (JP) 2017-107447

(51) Int. Cl. F02D 41/40

(52) U.S. Cl. CPC F02D 41/402; F02M 61/10; F02D 41/401

(57) ABSTRACT

Combustion stability can be improved while HC and PN discharged from a combustion chamber are prevented. In an ECU that controls a fuel injection device installed in a combustion chamber of an internal-combustion engine so as to be able to inject fuel in a direction intersecting with a sliding direction of a piston, a pressure value of the fuel supplied to the fuel injection device is acquired, control is performed such that the fuel injection device injects the fuel at least twice in a compression stroke, and control is performed such that fuel injection timing of at least one time in the compression stroke is advanced earlier than fuel injection timing of a time corresponding to the high pressure value of the fuel when the acquired fuel pressure value is low.

### TECHNICAL FIELD

The present invention relates to a fuel injection control device that controls a fuel injection device that injects fuel into a combustion chamber of an internal-combustion engine.

### BACKGROUND ART

In recent years, with the tightening of exhaust regulations, there is a demand for decreasing a total amount of unburned particles (PM: Particulate Matter) in exhaust from an engine during mode driving, the number of unburned particles (PN: Particulate Number), HC (hydrocarbon), and NOx (nitrogen oxide). PN and HC in the exhaust are generated when the fuel injected from the fuel injection device adheres to a piston and a bore wall surface of a combustion chamber. The number of unburned particles tends to increase when an equivalence ratio that is a ratio of air and fuel immediately before ignition is large, namely, when a region where the fuel is dense exists. It is effective to decrease fuel adhesion in order to prevent PN and HC. Because much HC is discharged more during start of the engine in which a catalyst is not activated, there is a demand for a technique of retarding ignition timing from the idle after completion of warm-up to increase an exhaust loss, and increasing an exhaust temperature to early raise the temperature of the catalyst.

In the ignition retard, combustion tends to become unstable because the ignition is performed in an expansion period in which the piston moves from a top dead center toward a bottom dead center after the compression stroke ends. Thus, in order to certainly perform the ignition, there is a demand for a technique of forming a rich air-fuel mixture necessary for the ignition around the ignition plug.

A technique, in which a cavity is formed in a crown surface of the piston, fuel is injected in the compression stroke to raise the air-fuel mixture put into the cavity, thereby collecting the air-fuel mixture around the ignition plug, is effective in order to form the rich air-fuel mixture around the ignition plug in ignition timing. However, when the fuel is injected in the compression stroke, sometimes the injected fuel adheres to the piston, and HC discharged from the combustion chamber increases.

For example, a technique of changing a position to which the air-fuel mixture adheres for each cycle by changing injection timing of the compression stroke and the fuel pressure supplied to the fuel injection device for each combustion cycle is known as a technique of decreasing the fuel adhesion to the piston (for example, see PTL 1).

### CITATION LIST

### Patent Literature

PTL 1: International Publication No. 2016/199297

### SUMMARY OF INVENTION

### Technical Problem

For example, during catalyst warm-up after the engine start, it is necessary to inject the fuel in the compression stroke in order to ensure the air-fuel mixture around the ignition plug necessary for the combustion stability. In particular, for side injection in which the fuel injection device is attached to a side surface of the combustion chamber, it is necessary to increase an injection amount injected in the compression stroke in order to form the air-fuel mixture around the ignition plug in the ignition timing. In the compression stroke, because of a short geometric distance between the fuel injection device and the crown surface of the piston, there is a problem in that the injected fuel tends to adhere to the piston to increase HC and PN discharged from the combustion chamber.

During the catalyst warm-up, because of a low temperature of a cylinder wall of the engine, sometimes the fuel injected in the intake stroke adheres to the cylinder wall surface to increase HC and PN discharged from the combustion chamber.

A transition period, in which pressure of the fuel supplied to the fuel injection device increases gradually from a low state to a target pressure or a rotation velocity of the engine (engine speed) increases to a target velocity, exists because the catalyst warm-up is immediately after the engine start.

In the transition period, it is considered that penetration force of a spray injected from the fuel injection device changes, and that a reach distance of the spray changes. For this reason, there is a risk that HC and PN discharged from the combustion chamber are increased or the air-fuel mixture necessary for the ignition around the ignition plug is hardly formed.

The present invention is made in view of the above situation, and an object of the present invention is to provide a technique of being able to improve the combustion stability while preventing HC and PN discharged from the combustion chamber.

### Solution to Problem

In order to achieve the above object, a fuel injection control device according to one aspect of the present invention controls a fuel injection device installed in a combustion chamber of an internal-combustion engine so as to be able to inject fuel in a direction intersecting with a sliding direction of a piston, the fuel injection control device includes: an acquisition unit that acquires a pressure value of the fuel supplied to the combustion injection device; and an injection controller that performs control such that the fuel injection device injects the fuel at least twice in a compression stroke. The injection controller performs control such that fuel injection timing of at least one time in the compression stroke is advanced earlier than fuel injection timing of a time corresponding to the high pressure value of the fuel when the fuel pressure value acquired by the acquisition unit is low.

### Advantageous Effects of Invention

According to the present invention, HC and PN discharged from the combustion chamber can be prevented, and the combustion stability can be improved.

### BRIEF DESCRIPTION OF DRAWINGS

FIG. 1 is a schematic general view illustrating an engine system according to a first embodiment.

FIG. 2 is a longitudinal sectional view illustrating a fuel injection device of the first embodiment, and is a view illustrating a connection relationship of an ECU.

FIG. 3 is an enlarged sectional view illustrating a part of the fuel injection device of the first embodiment.

FIG. 4 is a view illustrating temporal changes in a general injection pulse, drive voltage, drive current, and valve body displacement amount when the fuel injection device is driven.

FIG. 5 is a detailed configuration diagram illustrating the ECU of the first embodiment.

FIG. 6 is a schematic diagram illustrating a configuration in the cylinder of an engine and a circumference of the engine of the first embodiment.

FIG. 7 is a configuration diagram illustrating parts of an intake system and an exhaust system of the engine of the first embodiment.

FIG. 8 is a view illustrating a relationship between a general crank angle and injection timing during engine operation.

FIG. 9 is a projection view illustrating fuel spray injected from an orifice of the fuel injection device when facing a direction of the fuel injection device in a section A-A′ of FIG. 6.

FIG. 10 is a view illustrating the relationship between the crank angle and the injection timing when the fuel pressure is high during catalyst warm-up in the first embodiment.

FIGS. 11A and 11B are views illustrating a velocity vector of air flow in a combustion chamber of the engine of the first embodiment.

FIG. 12 is a view illustrating a distribution of an equivalence ratio of an air-fuel mixture in the combustion chamber of the engine at a point of time of each crank angle in the first embodiment.

FIG. 13 is a view illustrating a relationship between an elapsed time from start of the engine and the amount of an ignition retard, a fuel pressure, a fuel injection amount, and an engine speed of the first embodiment.

FIG. 14 is a view illustrating the relationship between the crank angle and the injection timing when the fuel pressure is low during the catalyst warm-up in the first embodiment.

FIG. 15 is a view illustrating temporal changes in the injection pulse, the drive voltage, the drive current, and the valve body displacement amount for driving a fuel injection device according to a second embodiment.

FIG. 16 is a view illustrating the relationship between the crank angle and the injection timing when the fuel pressure is low in a third embodiment.

FIG. 17 is a view illustrating the relationship between an engine speed and the equivalence ratio of the air-fuel mixture around an ignition plug.

FIGS. 18A to 18C are views illustrating the distribution of the equivalence ratio of the air-fuel mixture in the combustion chamber of the engine at the point of time of each crank angle.

FIG. 19 is a view illustrating the relationship between the elapsed time from the start of the engine and the amount of the ignition retard, an intake pressure, the fuel pressure, the fuel injection amount, and the engine speed according to a fifth embodiment.

FIG. 20 is a view illustrating a relationship between the fuel pressure and a particle size of the fuel injected from the fuel injection device.

FIG. 21 is a view illustrating the relationship between the crank angle and the injection timing according to a sixth embodiment.

FIG. 22 is an enlarged view illustrating the orifice of the fuel injection device of the first embodiment.

FIG. 23 is a sectional view illustrating the orifice in a section B-B′ of FIG. 22.

FIG. 24 is a view illustrating the relationship between the crank angle and the injection timing after the catalyst warm-up in the first embodiment.

### DESCRIPTION OF EMBODIMENTS

Several embodiments will be described with reference to the drawings. The following embodiments do not limit the invention according to the claims, and all the constituents described in the embodiments and combinations thereof are not essential for the solution of the invention.

An engine system according to a first embodiment will be described.

FIG. 1 is a schematic general view illustrating the engine system of the first embodiment.

An engine system 100 includes a fuel injection device 101 and an ECU (Engine Control Unit) 150 as an example of a fuel injection control device. An engine (internal-combustion engine) of the engine system 100 is a direct injection engine, and the fuel injection device 101 is installed for each of a plurality of (in the example of FIG. 1, four) cylinders 108 such that fuel spray is directly injected into a combustion chamber 107 in the cylinder 108. The fuel stored in a fuel tank (not illustrated) is boosted by a fuel pump 106, sent to a rail-shaped fuel piping 105, and delivered from the fuel piping 105 to each fuel injection device 101. A pressure sensor 102 that measures pressure of the fuel (referred to as fuel pressure) in the fuel piping 105 is installed in the fuel piping 105.

The fuel pressure in the fuel piping 105 varies depending on a balance between a flow rate of the fuel discharged by the fuel pump 106 and an injection amount (fuel injection amount) of the fuel injected into each combustion chamber 107 by each fuel injection device 101.

In the first embodiment, the ECU 150 controls a discharge amount of the fuel pump 106 such that the fuel pressure in the fuel piping 105 becomes a predetermined target pressure value based on sensor information (information indicating a fuel pressure value) output from the pressure sensor 102.

The fuel injection by the fuel injection device 101 is controlled by an injection pulse sent from a CPU 104 of the ECU 150. The injection pulse is input to a drive circuit 103 of the ECU 150. The drive circuit 103 decides a drive current waveform based on a command from the CPU 104, and supplies the drive current waveform to the fuel injection device 101 only for time based on the injection pulse.

The drive circuit 103 and the CPU 104 of the ECU 150 may be mounted on a board as an integral component.

Configurations and basic operations of the fuel injection device 101 and the ECU 150 will be described below.

FIG. 2 is a longitudinal sectional view illustrating the fuel injection device of the first embodiment, and is a view illustrating a connection relationship of the ECU. FIG. 3 is an enlarged sectional view illustrating a part of the fuel injection device of the first embodiment.

The CPU 104 of the ECU 150 takes in various signals indicating a state of the engine from various sensors, and calculates a width of the injection pulse and injection timing in order to control the amount of fuel injected from the fuel injection device 101 according to engine operating conditions. The CPU 104 outputs the injection pulse corresponding to a calculation result to the drive circuit 103.

The CPU 104 includes an A/D converter (not illustrated), an I/O port, and the like for in order to capture signals from various sensors. Examples of the various sensors include a sensor that can measure an engine speed (rotation velocity) (for example, a sensor that detects a rotation angle of a crankshaft (not illustrated) of the engine), a pressure sensor 102 that measures the fuel pressure in the fuel piping 105, and an exhaust temperature sensor that measures an exhaust temperature.

The injection pulse output from the CPU 104 is input to the drive circuit 103 through a signal line 110. The drive circuit 103 controls voltage applied to a solenoid 205 of the fuel injection device 101, and supplies current. The CPU 104 can communicate with the drive circuit 103 through a communication line 111, performs the control such that the drive current generated by the drive circuit 103 is switched by the pressure of the fuel supplied to the fuel injection device 101 or the operation conditions, and change setting values of the drive current and the time the current is output.

The fuel injection device 101 is a normally closed electromagnetic valve (electromagnetic fuel injection device), and includes the solenoid 205 as an example of a coil, a needle 202, and a valve body 214. In the fuel injection device 101, while the solenoid 205 is not energized, the valve body 214 is biased in a valve closing direction by a spring 210, and is in close contact with a valve seat 218 (valve closed state).

The needle 202 is biased in a valve opening direction by a return spring 212. In the valve closed state, because force acting on the valve body 214 by the spring 210 is larger than force by the return spring 212, the needle 202 comes into contact with a collar 302 of the valve body 214 and becomes a stationary state.

The valve body 214 and the needle 202 are configured to be relatively displaceable, and contained in a nozzle holder 201. The nozzle holder 201 has an end face 304 that acts as a spring seat for the return spring 212. Biasing force by the spring 210 is adjusted during assembly by a pushing amount of a spring retainer 224 fixed to an inner diameter of a fixed core 207.

In the fuel injection device 101, a magnetic circuit is constructed with the fixed core 207, the needle 202, the nozzle holder 201, and a housing 203. A gap 301 is provided between the needle 202 and the fixed core 207. A magnetic throttle 211 is formed in a portion corresponding to the gap 301 of the nozzle holder 201 (the outer circumferential side of the gap 301).

The solenoid 205 is attached to the outer circumferential side of the nozzle holder 201 while wound around a bobbin 204. A rod guide 215 is fixed at a position near a leading end of the valve body 214 of the nozzle holder 201 on the side of the valve seat 218. With this configuration, the valve body 214 moves while guided in a valve shaft direction (vertical direction in the drawing) by two sliding locations, namely, a location where the collar 303 of the valve body 214 and the fixed core 207 slide and a location where the valve body 214 and the rod guide 215 slide. An orifice 216 in which the valve seat 218 and a fuel injection hole 219 are formed is fixed to the leading end of the nozzle holder 201. With this configuration, the leading end of the valve body 214 and the valve seat 218 of the orifice 216 come in contact with each other, thereby sealing an internal space (fuel passage) between the nozzle holder 201 and the valve body 214 (valve closed state).

The fuel supplied from the fuel piping 105 to the fuel injection device 101 flows to a leading-end side of the valve body 214 through a fuel passage hole 231 when the fuel injection device 101 is in the valve closed state. However, a leading-end portion of the valve body 214 on the side of the valve seat 218 and the valve seat 218 are in contact with each other, and the inside is sealed, so that the fuel is not injected to the outside through the fuel injection hole 219 of the orifice 216. When the fuel injection device 101 is in the valve closed state, a differential pressure is generated between an upper portion and a lower portion of the valve body 214 due to the fuel pressure, and the valve body 214 is pushed in the valve closing direction by differential pressure force obtained by multiplying the fuel pressure and a pressure receiving area at a valve seat position and a load of the spring 210.

When the supply of the current to the solenoid 205 is started while the fuel injection device 101 is in the valve closed state, a magnetic field is generated in the magnetic circuit, a magnetic flux passes between the fixed core 207 and the needle 202, and magnetic attractive force acts on the needle 202. The needle 202 starts displacement in the direction of the fixed core 207 in timing when the magnetic attractive force acting on the needle 202 exceeds a load of the differential pressure force and the spring 210. After the valve body 214 starts the valve opening operation, the needle 202 moves so as to approach the fixed core 207, and collides with the fixed core 207. Although the needle 202 receives reaction force from the fixed core 207 to perform a rebound operation after the needle 202 collides with the fixed core 207 in this way, the needle 202 is attracted in the fixed core 207 by the magnetic attractive force acting on the needle 202, and eventually stops to end the valve opening operation. At this point, force acts on the needle 202 in the direction of the fixed core 207 by the return spring 212, so that the time until the rebound converges can be shortened. Because the rebounding operation is small, the time the gap between the needle 202 and the fixed core 207 increases is shortened, and stable operation can be performed even with a smaller width of the injection pulse.

The needle 202 and the valve body 214 that end the valve opening operation in this manner stand still in a valve open state. In the valve open state, the gap is formed between the valve body 214 and the valve seat 218, and the fuel is injected from the fuel injection hole 219. The fuel supplied through the fuel passage hole 231 passes through a center hole made in the fixed core 207 and a lower fuel passage hole 305 made in the needle 202, and flows in a downstream direction (the side of the fuel injection hole 219).

Thereafter, when the energization to the solenoid 205 of the fuel injection device 101 is cut off, the magnetic flux generated in the magnetic circuit disappears, and the magnetic attractive force also disappears. When the magnetic attractive force acting on the needle 202 disappears in this way, the needle 202 and the valve body 214 are pushed back to a valve closed position contacting with the valve seat 218 by the load of the spring 210 and the differential pressure.

In this way, when the valve body 214 changes from the valve open state to the valve closed state, the needle 202 separates from the valve body 214 to move in the valve closing direction after the valve body 214 comes into contact with the valve seat 218, and the needle 202 is returned to an initial position of the valve closed state by the action of the return spring 212 after moving for a certain period of time. In this way, when the needle 202 separates from the valve body 214 at a moment when the valve body 214 becomes the valve closed state, because a mass at the moment when the valve body 214 collides with the valve seat 218 can be decreased by a mass of the needle 202, collision energy can be decreased when the valve body 214 collides with the valve seat 218, and bound of the valve body 214 caused by the collision of the valve body 214 with the valve seat 218 can be prevented.

In the fuel injection device 101 of the first embodiment, the relative displacement is generated between the valve body 214 and the needle 202 in a short time between the moment when the needle 202 collides with the fixed core 207 during the valve opening and the moment when the valve body 214 collides with the valve seat 218 during the valve closing, which allows the prevention of the bound of the needle 202 to the fixed core 207 and the bound of the valve body 214 to the valve seat 218.

A configuration of the ECU of the first embodiment will be described below.

FIG. 5 is a detailed configuration diagram of the ECU of the first embodiment.

The ECU 150 includes the CPU 104 as an example of an acquisition unit, an injection controller, an ignition controller, an intake controller, a supercharging controller, and a rotation velocity acquisition unit and the drive circuit 103. The CPU 104 captures sensor values from the pressure sensor 102 attached to the fuel piping 105 of an upstream of the fuel injection device 101, an A/F (Air Flow) sensor that measures an amount of air flowing into the cylinder 108, an oxygen sensor that detects an oxygen concentration of an exhaust gas discharged from the combustion chamber 107, a sensor, such as a crank angle sensor, which acquires a signal (information) indicating the state of the engine, and the like, calculates an injection pulse Ti (that is, equivalent to the injection amount) and the injection timing in order to control the fuel injection amount injected from the fuel injection device 101 according to the operating state of the internal-combustion engine, and outputs an injection pulse width Ti to a drive IC 502 of the drive circuit 103 through the communication line 504. The CPU 104 performs the control for igniting the ignition plug 604 according to the operating condition of the internal-combustion engine.

Based on the injection pulse width Ti, the drive IC 502 switches the energization and non-energization of switching elements 505, 506, 507 to supply the drive current to the fuel injection device 101.

A register and a memory are installed on the CPU 104 in order to store numerical data, such as calculation of the injection pulse width, which is necessary for engine control. The register and the memory may be mounted on a unit except for the CPU 104 in the ECU 150.

For example, the switching elements 505, 506, 507 are constructed with FETs or transistors. The switching elements 505, 506, 507 can switch between the energization and the non-energization of the fuel injection device 101.

The switching element 505 is connected between a high-voltage power supply (booster circuit 514) that outputs the voltage higher than a low voltage (battery voltage) VB from a low-voltage power supply (for example, a battery) input to the drive circuit 103 and a terminal (high-voltage terminal) 590 of the fuel injection device 101 on a high-voltage side of the solenoid 205. At this point, for example, the voltage value of the battery voltage VB ranges from about 12 V to about 14 V. For example, a boosted voltage VH that is an initial voltage value of the high-voltage power supply is 60 V, and is generated by boosting the battery voltage VB using the booster circuit 514. For example, the booster circuit 514 may be constructed with a DC/DC converter, or constructed with a coil 530, a transistor 531, a diode 532, and a capacitor 533 as illustrated in FIG. 5. For the booster circuit 514 in FIG. 5, the battery voltage VB flows to the side of a ground potential 534 when the transistor 531 is turned on, and the high voltage generated in the coil 530 is rectified through the diode 532 to accumulate charges in the capacitor 533 when the transistor 531 is turned off. Until the voltage output from the booster circuit 514 reaches the boosted voltage VH, the transistor 531 is repeatedly turned on and off, and the voltage at the capacitor 533 is increased. The transistor 531 is connected to the drive IC 502 or the CPU 104, and on and off of the transistor 531 are controlled by the drive IC 502 or the CPU 104. The voltage output from the booster circuit 514 is detected by the drive IC 502 or the CPU 104.

A diode 535 is provided between a high-voltage terminal 590 of the solenoid 205 and the switching element 505 such that the current flows from the high-voltage supply in the directions of the solenoid 205 and a ground potential 515, and a diode 511 is also provided between the high-voltage terminal 590 of the solenoid 205 and the switching element 507 such that the current flows from the battery in the directions of the solenoid 205 and the ground potential 515. For this reason, while the switching element 506 is energized, because the current flows from the battery to the ground potential 515 through the switching element 506, the current does not flow from the ground potential 515 toward the solenoid 205, the battery, and the high-voltage power supply.

The switching element 507 is connected between the low-voltage power supply (battery) and the high-voltage terminal 590 of the fuel injection device 101. The switching element 506 is connected between a terminal 591 on the low-voltage side of the fuel injection device 101 and the ground potential 515. The drive IC 502 detects the current value flowing through the fuel injection device 101 using current detection resistors 508, 512, 513, and switches the energization and the non-energization of the switching elements 505, 506, 507 according to the detected current value to generate the desired drive current. The diodes 509 and 510 are provided in on order to apply a reverse voltage to the solenoid 205 of the fuel injection device 101 to rapidly decrease the current supplied to the solenoid 205. The CPU 104 communicates with the drive IC 502 through the communication line 503, and can switch the drive current generated by the drive IC 502 depending on the pressure of the fuel supplied to the fuel injection device 101 and the operation conditions. Both ends of each of the resistors 508, 512, 513 are connected to an A/D conversion port of the drive IC 502, and the voltage applied to both ends of each of the resistors 508, 512, 513 can be detected by the drive IC 502.

The injection pulse output from the CPU 104, the drive voltage at both ends of the terminal in the solenoid 205 of the fuel injection device 101, the drive current (excitation current), and the displacement amount of the valve body 214 of the fuel injection device 101 (valve behavior)) will be described below.

FIG. 4 is a view illustrating temporal changes in the general injection pulse, drive voltage, drive current, and valve body displacement amount when the fuel injection device is driven.

When the injection pulse (on) is input from the CPU 104 to the drive IC 502, the drive IC 502 energizes the switching elements 505, 506, applies a voltage 401 (the boosted voltage VH boosted by the booster circuit 514) higher than the battery voltage to the solenoid 205, and starts the supply of the current to the solenoid 205. The drive IC 502 stops the application of the high voltage 401 when the current value supplied to the solenoid 205 reaches a peak current value Iₚₑₐₖ previously decided by the CPU 104. Subsequently, the drive IC 502 deenergizes the switching element 505, the switching element 506, and the switching element 507. As a result, the diode 509 and the diode 510 are energized by counter electromotive force due to inductance of the fuel injection device 101, the current is fed back to the side of the high-voltage power supply (booster circuit 514), and the current supplied to the fuel injection device 101 is rapidly decreases from the peak current value Iₚₑₐₖ like the current 402. The switching element 506 may be turned on during a transition period from the peak current value Iₚₑₐₖ to a current 403 (holding current). Consequently, the current caused by counter electromotive force energy flows onto the side of the ground potential 515, the current is regenerated in the circuit, and the voltage of almost 0 V is applied to the solenoid 205 to gently decrease the current.

When the current value becomes smaller than a predetermined current value 404, the drive IC 502 energizes the switching element 506 to set a switching period in which the application of the battery voltage VB is controlled such that the predetermined current 403 is maintained by controlling the energization and the non-energization of the switching element 507. At this point, when the fuel pressure supplied to the fuel injection device 101 increases, fluid force acting on the valve body 214 increases, and the time until the valve body 214 reaches a target opening degree is lengthened. As a result, sometimes the timing when the valve body 214 reaches the target opening is delayed with respect to the time the current reaches the peak current Iₚₑₐₖ but the magnetic attractive force acting on the needle 202 also decreases rapidly when the current is rapidly decreased like the current 402. For this reason, a behavior of the valve body 214 becomes unstable, and in some cases, the valve closing is started even during the energization. When the switching element 505 is turned on to gently decrease the current during a transition from the peak current Iₚₑₐₖ to the current 403, the decrease in the magnetic attractive force can be prevented, and the stability of the valve body 214 at the high fuel pressure can be secured to prevent a variation in the injection amount.

The fuel injection device 101 is driven by such a profile of the drive current. Between the application of the high voltage 401 and the peak current value Iₚₑₐₖ the needle 202 and the valve body 214 start the displacement at timing t₄₁, and reach the maximum height position. At timing t₄₂ when the needle 202 reaches the maximum height position, the needle 202 collides with the fixed core 207 to perform the bound operation between the needle 202 and the fixed core 207. Because the valve body 214 is configured to be relatively displaceable with respect to the needle 202, the valve body 214 separates from the needle 202, and the displacement of the valve body 214 overshoots beyond the maximum height position. Subsequently, by the magnetic attraction force generated by the holding current 403 and the force of the return spring 212 in the valve opening direction, the needle 202 stands still at the predetermined maximum height position, and the valve body 214 is seated on the needle 202 to stand still at the maximum height position, and becomes the valve open state.

For the fuel injection device including a movable valve in which the valve body and the needle are integrated, the displacement amount of the valve body does not become larger than the maximum height position, but the needle and the valve body are equal to each other in the displacement amount after the valve body reaches the maximum height position.

A configuration in the cylinder of the engine and a circumference of the engine of the first embodiment will be described below.

FIG. 6 is a schematic diagram illustrating the configuration in the cylinder of the engine and the circumference of the engine of the first embodiment. The engine in FIG. 6 is an in-cylinder direct injection type engine (direct injection engine) that directly injects the fuel into the cylinder 108 of the engine. FIG. 6 is a sectional view at the center in the cylinder 108 of the engine, and illustrates a state immediately after the fuel is injected from the leading end of the orifice 216 of the fuel injection device 101. In the direct injection engine including two intake valves 605 and two exhaust valves 610, although the intake valve 605 and the exhaust valve 610 are not visible in the section at the center of the cylinder of the engine, the intake valve 605 and the exhaust valve 610 are illustrated in FIG. 6 for convenience.

The engine includes the fuel injection device 101, the ignition plug 604, an intake port 607, an exhaust port 608, a piston 609, the intake valve 605, and the exhaust valve 610.

A cavity 606 lower than the upper end of the piston 609 on the side of the ignition plug 604 is formed on the surface (crown surface) of the piston 609 on the side of the ignition plug 604. The cavity 606 has a function of temporarily holding the air-fuel mixture of the fuel injected from the fuel injection device 101 and air taken in from the intake port 607. In the first embodiment, the cavity 606 refers to a deepest portion from the upper end (farthest from the side of the ignition plug 604) in the crown surface of the piston 609 on the side of the ignition plug 604. The cavity 606 is formed in the range where an extension line 618 in a stroke direction (sliding direction) of the piston 609 in a gap 617 that is a region including an ignition position at which a spark is generated between a negative electrode 612 and a positive electrode 613 of the ignition plug 604 falls within the cavity 606. In the first embodiment, in the direction perpendicular to the stroke direction, the cavity 606 is formed from the side of the intake port 607 (the left side of the drawing) to the range closer to the gap 617 on the side of the exhaust port 608 (the right side of the drawing) than the intersection with the extension line 618 in the stroke direction of the piston 609. With this configuration, the air-fuel mixture held in the cavity 606 is located immediately below the gap 617 (on the extension line 618) of the ignition plug 604, so that the air-fuel mixture in the cavity 606 can efficiently be combusted by the ignition using the ignition plug 604 by raising the air-fuel mixture in the cavity 606 onto the side of the ignition plug 604.

A fixed type partition wall 602 that divides an air flow into an upper passage (first passage) 620 and a lower passage (second passage) 611 of the intake port 607 is attached to the intake port 607, and a valve 601 that opens and closes (releases and blocks) the side of the lower passage 611 is provided upstream of the lower passage 611. The valve 601 is configured so as to be able to control the valve opening and the valve closing under the control of the CPU 104. FIG. 6 illustrates a state where the valve 601 is closed.

A part of the configuration relating to intake and exhaust in the engine will be described below.

FIG. 7 is a configuration diagram illustrating parts of an intake system and an exhaust system of the engine of the first embodiment.

Air is taken in from the intake port (not illustrated) into the combustion chamber 107 of the engine through an air cleaner 701, a supercharging chamber 704, an intercooler 705, a throttle valve 706, and the intake port 607. The air cleaner 701 removes dust in the taken-in air.

As a result, abrasion of the inside of the engine due to the intake of the dust into the engine is prevented.

A supercharger 702 is provided in the supercharging chamber 704. The supercharger 702 includes a compressor 702A that compresses the air on the intake side, a turbine 702B that is disposed on the exhaust side and rotated by the flow of exhaust gas, a compressor 702A, and a shaft 707 connected to the turbine 702B. In the supercharger 702, the turbine 702B is rotated according to the flow rate of the exhaust gas, and the compressor 702A is rotated through the shaft 707. As a result, the air passing through the air cleaner 701 is compressed by the rotation of the compressor 702A, and flows onto the side of the intercooler 705. As a result, the amount of air flowing into the combustion chamber 107 of the engine can be increased, and the output of the engine can be improved. Because the air passing through the supercharging chamber 704 is compressed by the compressor 702A, a temperature of the air rises.

The intercooler 705 cools the air in which the temperature rises due to the compression by the compressor 702A. The throttle valve 706 adjusts the amount of air taken in the combustion chamber 107 of the engine. The opening degree of throttle valve 706 is controlled by the ECU 150 based on the opening degree of an accelerator (not illustrated) and the like.

The intake valve 605 is provided in the intake port 607, and the air flows into the combustion chamber 107 of the engine by opening the intake valve 605 at predetermined timing.

The fuel injection device 101 is disposed in the engine so as to inject the fuel from the direction intersecting with the stroke direction of the piston 609 on the side of the intake port 607 toward the combustion chamber 107.

In the combustion chamber 107 of the engine, the inflow air and the fuel injected from the fuel injection device 101 are mixed to form the air-fuel mixture, and the air-fuel mixture is combusted by the ignition using the ignition plug 604. The force generated by the combustion of the air-fuel mixture is transmitted to a crankshaft (not illustrated) through the piston 609 and a connecting rod 710.

The exhaust gas generated by the combustion of the air-fuel mixture in the combustion chamber 107 passes through the exhaust port 608 to rotate the turbine 702B of the supercharger 702 when the exhaust valve 610 is open during an expansion stroke. The exhaust gas that rotates the turbine 702B passes through a catalyst 703, and is discharged to the outside. The catalyst 703 is a three-way catalyst having a catalyst made of, for example, palladium, rhodium, and platinum, and HC, NOx, CO (carbon monoxide) contained in the exhaust gas are removed by reducing or oxidizing HC, NOx, CO using the catalyst. Because the catalyst 703 has a low reducing ability at a low temperature, warming-up is required to early warm the temperature of the catalyst 703 immediately after the engine is started.

The control of the general injection timing during the engine operation will be described below.

FIG. 8 is a view illustrating a relationship between a general crank angle and injection timing during the engine operation. In FIG. 8, a horizontal axis indicates an angle (crank angle) of the crankshaft, and a vertical axis indicates a lift amount of the intake valve, a turbulent velocity of the air in the combustion chamber 107, and a tumble. In FIG. 8, the lift amount of the intake valve 605 is indicated by a dotted line, the average value of the turbulent velocity of the air in the combustion chamber 107 of the engine is indicated by a broken line, and the tumble in the combustion chamber 107 is indicated by a solid line. In the crank angle, a TDC (top dead center) of an intake stroke is set to −360 deg, a BDC (bottom dead center) is set to −180 deg, and the TDC of a compression stroke is set to 0 deg.

The ECU 150 starts the opening of the intake valve 605 and takes the air into the combustion chamber 107 at timing t81 when the piston 609 reaches the TDC and immediately before or at the same time as the closing of the exhaust valve 610.

Subsequently, the ECU 150 performs the injection in an intake stroke 802 at timing t82 (crank angle of −300 deg) until the intake valve 605 starts the opening and reaches the maximum lift.

Subsequently, the piston 609 reaches the BDC, and enters a compression stroke 803, and the ECU 150 performs the injection in the compression stroke at timing t83 (crank angle of −60 deg) before the piston 609 reaches the TDC.

Subsequently, at timing t84 after the piston 609 reaches the TDC, the ECU 150 performs the ignition using the ignition plug 604, and ignites and combusts the air-fuel mixture.

At this point, in order to ensure the air-fuel mixture around the electrode of the ignition plug 604 at the ignition timing t84, it is conceivable to increase the injection amount in the compression stroke 803. However, in the compression stroke 803, because of a close distance between the fuel injection device 101 and the piston 609, sometimes the fuel injected from the fuel injection device 101 may adhere to the piston 609 to increase HC and PN.

The state of the spray injected from the fuel injection device 101 of the first embodiment will be described below.

FIG. 9 is a projection view illustrating the fuel spray injected from the orifice of the fuel injection device when facing the direction of the fuel injection device in a section A-A′ of FIG. 6.

The fuel injection device 101 is a multi-hole type fuel injection device including a plurality of fuel injection holes. For example, the fuel injection device 101 includes a total of six fuel injection holes of a fuel injection hole that forms a spray D1 directed to the ignition plug 604, two fuel injection holes that form sprays D2, D6 injected in the direction close to the intake valve 605, and three fuel injection holes that form sprays D3, D4, D5 directed to the side of the piston 609.

The spray of the fuel injection device 101 is based on a concept that the spray D4 is put into the cavity 606 to form the air-fuel mixture having the high equivalence ratio in a vicinity of the ignition plug 604 in the fuel injection of the compression stroke. The sprays D1, D2, D6 may be put into the cavity 606 depending on a dimension of the cavity 606 and the injection timing.

The fuel injection device 101 of the first embodiment may be configured such that the flow rates of the sprays D3, D4, D5 directed in the direction of the piston 609 are smaller than those of the sprays D1, D2, D6. With this configuration, even if the fuel is injected during the compression stroke, the fuel adhesion to the piston 609 can be prevented to decrease PN and HC. Specifically, for example, the diameter of the fuel injection holes may be reduced such that a sectional area of the fuel injection hole in each of the sprays D3, D4, D5 is smaller than that of the fuel injection hole in each of the sprays D1, D2, D6.

Subsequently, the fuel injection timing when the fuel pressure is high (the fuel pressure is greater than or equal to a predetermined target fuel pressure) during the catalyst warm-up in the first embodiment will be described below.

FIG. 10 is a view illustrating the relationship between the crank angle and the injection timing when the fuel pressure is high during the catalyst warm-up in the first embodiment. In FIG. 10, the horizontal axis indicates the crank angle, and the vertical axis indicates the lift amount of the intake valve, an average value of the turbulent velocity of the air in the combustion chamber 107, and the tumble. In FIG. 10, the lift amount of the intake valve 605 is indicated by the dotted line, the average value of the turbulent velocity of the air in the combustion chamber 107 of the engine is indicated by the broken line, and the tumble in the combustion chamber 107 is indicated by the solid line. In the crank angle, a TDC (top dead center) of an intake stroke is set to −360 deg, a BDC (bottom dead center) is set to −180 deg, and the TDC of a compression stroke is set to 0 deg. In the tumble, the counterclockwise direction is set to positive, and the clockwise direction is set to negative.

FIG. 11 is a view illustrating a velocity vector of the air flow in the combustion chamber of the engine of the first embodiment. FIG. 11(a) illustrates the velocity vector of the air flow at timing t108 when the turbulent velocity of the air in the combustion chamber 107 of the engine becomes the maximum, and FIG. 11(b) illustrates the velocity vector of the air flow at timing t110 when the tumble (absolute value) becomes the maximum.

At this point, for example, the ECU 150 can determine whether the catalyst is in the warming up based on whether to satisfy a predetermined condition that performs the catalyst warm-up such as the condition that an elapse time from engine start falls within a predetermined time or the condition that the temperature of the catalyst 703 is lower than or equal to a predetermined temperature.

When the catalyst is in the warming up while the fuel pressure is higher than the target fuel pressure, the ECU 150 controls the fuel injection device 101 such that the fuel injection is performed at least once when the piston 609 transitions from the TDC to the BDC in an intake stroke 1002. The fuel injection in the intake stroke 1002 is the injection for producing the homogeneous air-fuel mixture in the combustion chamber 107 of the piston 609. Fuel injection timing t102 is preferably set between timing t101 when the intake valve 605 starts the opening and timing t103 when the intake valve 605 reaches a maximum lift 1001.

In the fuel injection in the intake stroke 1002, the piston 609 moves toward the BDC, and the distance between the fuel injection device 101 and the piston 609 is longer than that in a compression stroke 1003. However, because the injection amount is larger than that in the compression stroke 1003, the injected fuel tends to adhere to a bore wall surface.

The fuel split ratio between the intake stroke 1002 and the compression stroke 1003 is preferably set to, for example, about 6:4, about 7:3, and about 8:2 such that the fuel injection amount in the intake stroke 1002 is increased.

The timing when the turbulent velocity of the air in the combustion chamber 107 of the engine becomes the maximum is determined depending on an opening velocity of the intake valve 605, and the turbulent velocity becomes the maximum at timing t108 when the sectional area of the intake valve 615 increases after the intake valve 605 starts the opening at timing t101. However, as illustrated in FIG. 11(a), at timing t108, the position of the piston 609 is close to the TDC, and the vertical distance in the combustion chamber 107 of the engine is small, so that the tumble that is a vertical vortex is formed small or not formed. The tumble becomes the maximum at timing t110 after timing t109 (crank angle of −270 deg) between the TDC and the BDC in the intake stroke 1002 in which the velocity of the piston 609 becomes the maximum. As illustrated in FIG. 11(b), the tumble 1101 at the timing t110 has the strongest clockwise flow.

The ECU 150 decides the injection timing t102 of the intake stroke 1002 such that a period 1007 (hereinafter, referred to as an injection period) from the timing t102 when the injection 1004 of the intake stroke 1002 starts to timing t104 when the injection ends overlaps the timing t110 when the tumble becomes the maximum. The air-fuel mixture is caught in the tumble by performing the fuel injection during the strong tumble in this way, so that the fuel adhesion to the cylinder wall surface 614 can be prevented to decrease HC and PN in the exhaust gas even if the fuel injection amount in the intake stroke 1002 is increased.

As described above, because the timing t110 when the tumble becomes the maximum comes after the timing t109 when the velocity of the piston 609 becomes the maximum (crank angle of −270 deg) and until the timing t103 when the lift amount of the intake valve 605 becomes the maximum, the ECU 150 preferably sets the injection timing t102 such that at least a part of the injection period 1007 of the intake stroke 1002 overlaps the period 1008 after the crank angle of −270 deg and when the lift amount of the intake valve 605 becomes the maximum. At this point, the ECU 150 acquires the sensor value (crank angle information) from a crank angle sensor attached to the crankshaft (not illustrated), so that the ECU 150 can calculate the period 1008 to set the injection timing t102 based on the crank angle information.

Even if the timing t101 when the intake valve 605 starts the opening changes depending on the engine speed, operating conditions, and the like, the injection timing t102 in the intake stroke 1002 can appropriately be set by controlling the injection timing of the fuel injection in the intake stroke 1002 in this way. As a result, the fuel adhesion to the cylinder wall surface 614 can be prevented to enhance the effect that decreases PN and HC.

The orifice 216 of the fuel injection device 101 will be described below.

FIG. 22 is an enlarged view illustrating the orifice of the fuel injection device of the first embodiment. FIG. 23 is a sectional view illustrating the orifice in a section B-B′ of FIG. 22.

Six fuel injection holes, namely, fuel injection holes 2301, 2302, 2303, 2304, 2305, and 2306 are made in the orifice 216. The sprays injected from the fuel injection holes correspond to the sprays D1, D2, D3, D4, D5, and D6 in FIG. 9. The fuel injection holes 2301, 2302, 2306 correspond to the first fuel injection hole, and the fuel injection holes 2303, 2304, 2305 correspond to the second fuel injection hole.

In the combustion chamber 107 of the first embodiment, the air taken in the upper passage 620 of the intake port 607 flows by closing the partition wall 602 and the valve 601 in FIG. 6, and the tumble 1101 that is a clockwise air flow is formed in the combustion chamber 107. For this reason, the air-fuel mixture including the injected spray floats easily on the flow by setting the flow rates of the sprays D1, D2, D6 injected in the tumble direction to be larger than the flow rates of the sprays D3, D4, D5 injected in the piston direction, and the fuel adhesion to the piston 609 or the cylinder wall surface 614 in the intake stroke 1002 can be prevented to enhance the effect that decreases HC.

At this point, a fuel injection amount Q injected from the fuel injection hole is given by the following equation (1), where Ao is the sectional area of the fuel injection hole and V is the flow velocity of the fuel at the outlet port of the fuel injection hole.

Q=Ao·V (1)

According to the equation (1), the fuel injection amount can be decreased by reducing the sectional area Ao, namely, by decreasing the diameter of the fuel injection hole, and the fuel injection amount can be increased by enlarging the sectional area Ao, namely, by increasing the diameter of the fuel injection hole.

Thus, in order to increase the flow rates of the sprays D1, D2, D6 larger than the flow rates of the sprays D3, D4, D5, the inner diameters of the fuel injection holes 2301, 2302, 2306 (for example, the inner diameter 2311 of the fuel injection hole 2301) (FIG. 23)) may be configured to be larger than the inner diameters of the fuel injection holes 2303, 2304, 2305 (for example, the inner diameter 2314 of the fuel injection holes 2304 (see FIG. 23)).

In the sprays D1, D2, D6, the sprays D2, D6 are injected in the direction closer to the intake valve 605 than the spray D1, and are more susceptible to the flow, so that the fuel injection amounts of the sprays D2, D6 may be increased larger than the fuel injection amount of the spray D1. In order to provide this configuration, the sectional areas of the fuel injection holes 2302, 2306 of the sprays D2, D6 may be enlarged larger than the sectional area of the fuel injection hole 2301 of the spray D1.

With this configuration, even under the condition that the valve 601 is closed to increase the flow, the sprays D2, D6 are not easily affected by the flow, and the air-fuel mixture is easily formed. As a result, the homogeneity of the air-fuel mixture in the combustion chamber 107 of the engine can be improved, and the effect that decreases NOx can be obtained.

During the catalyst warm-up, sometimes the combustion becomes unstable because the ignition timing is retarded. In this case, the turbulent velocity of the air in the combustion chamber 107 of the engine at the ignition timing is secured to prevent the decrease of the combustion velocity by closing the valve 601, which allows the stable combustion. Thus, during the catalyst warm-up, the ECU 150 may perform the control so as to close the valve 601.

The sprays D1, D2, D6 may have spray penetration force, namely, a reach distance (referred to as penetration) shorter than that of the sprays D3, D4, D5. For this purpose, the bore diameter (inner diameter) of the cylinder 108, namely, the outer diameter of the piston 609 is decreased, and the stroke of the piston 609 is increased, thereby increasing the velocity of the piston 609 to promote collapse of the tumble in the compression stroke. The fuel injected by the injection 1004 in the intake stroke 1002 adheres easily to the cylinder wall surface 614 when the bore diameter of the cylinder 108 is decreased, so that the effect that prevents the fuel adhesion in the intake stroke 1002 to decrease HC and PN is enhanced by shortening the reach distances of the sprays D1, D2, D6 as compared with the reach distances of the sprays D3, D4, D5.

For example, the configuration of the sprays D1, D2, D3, D4, D5, D6 of the first embodiment is highly effective when being applied to a long-stroke engine in which a ratio of the bore to the stroke is greater than 1.0. Even if the fuel is injected in the compression stroke 1003, the injection amounts of the sprays D3, D4, D5 are smaller than the injection amounts of the sprays D1, D2, D6, so that the effect that prevents the fuel adhesion to the piston 609 is obtained. For example, a method for providing a tapered portion on the upstream side of the fuel injection holes 2303, 2304, 2305 of the sprays D3, D4, D5 is adopted as a method for shortening the penetration of the sprays D1, D2, D6 rather than the sprays D3, D4, D5. Specifically, as illustrated in FIG. 23, by providing a tapered portion 2424 on the upstream side of the fuel injection hole 2304, fuel separation can be prevented when the fuel enters the fuel injection hole in an entrance surface 2434 of the fuel injection hole 2304, and the penetration can be decreased by homogenizing a flow velocity distribution in a spray outlet surface.

The reach distance of the spray D4 may be set shorter than the reach distance of the spray D3, D5 because the spray D4 is shorter than the spray D3, D5 in a geometric distance between the fuel injection device 101 and the piston 609. In this way, the fuel adhesion to the piston 609 can be prevented to increase the effect that decreases HC and PN, the fuel is easily diffused in the whole space of the combustion chamber 107 by ensuring the reach distance of the sprays D3, D5, and the homogeneity of the air-fuel mixture can be enhanced to decrease the generation of NOx.

The reach distance of the spray D1 may be set shorter than that of the sprays D2, D6.

The spray D1 is shorter than the sprays D2, D6 in the geometric distance to the cylinder wall surface 614, and the spray D1 is farther from the intake valve 605 than the sprays D2, D6, so that the spray D1 is hardly affected by the flow. Thus, when the injection is performed in the intake stroke 1002, the reach distance of the spray D1 is shortened as compared with the sprays D2, D6, whereby the fuel adhesion to the cylinder wall surface 614 of the spray is prevented to enhance the effect that decreases HC and PN.

The configuration of the fuel injection device 101 is more effective for the fuel injection device attached to the side of the cylinder wall surface 614, namely, the case where the side injection is targeted as illustrated in FIG. 6. This is attributed to the following reason. That is, for the center injection in which the fuel injection device 101 is configured near the ignition plug 604, the equivalence ratio around the electrode of the ignition plug can be secured when the fuel is injected immediately before the ignition timing. On the other hand, for the side injection, because the geometric distance between the positive electrode 613 and the negative electrode 612 of the fuel injection device 101 and the ignition plug 604 is longer than that in the case of the center injection, the effect that divides the fuel injection of the compression stroke into at least two times appears markedly as described in detail later.

The fuel injection control in the compression stroke when the fuel pressure is high during the catalyst warm-up will be described below with reference to FIGS. 10 and 12.

FIG. 12 is a view illustrating a distribution of the equivalence ratio of the air-fuel mixture in the combustion chamber of the engine at a point of time of each crank angle in the first embodiment. In FIG. 12, the distribution of the equivalence ratio in the combustion chamber 107 at crank angles of −70, −55, −40, −10, +20 deg. ATDC (After TDC) is illustrated by a contour line. In FIG. 12, the value of the equivalence ratio is displayed on the contour line.

The ECU 150 sets at least two-time injection, namely, first-time injection 1005 (the injection (in the first embodiment, two times before) before the injection immediately before the ignition timing) of the compression stroke 1003 and second-time injection 1006 (the injection immediately before the ignition timing) as fuel injection in the compression stroke 1003. In the first embodiment, for example, the ECU 150 sets the first-time injection 1005 of the compression stroke 1003 to timing t105 (−60 deg), and sets the second-time injection 1006 of the compression stroke 1003 to timing t106 (−40 deg).

The first-time injection 1005 of the compression stroke 1003 (the injection before the injection immediately before the ignition timing t107) acts so as to form an air-fuel mixture 1201 in the cavity 606 of the piston 609, and the second-time injection 1006 (the injection immediately before the ignition timing t107) acts so as to raise the air-fuel mixture 1201 formed in the cavity 606 to the side of the negative electrode 612 of the ignition plug 604.

As illustrated in FIG. 12, when an axis of a gravity center of the spray D1 is set to a gravity center axis 1203, and when an axis of a gravity center of the spray D4 is set to a gravity center axis 1204, the flow rate of the spray D4 is decreased due to a shear resistance with the wall surface (top surface) of the piston 609 because the gravity center axis 1204 is close to the cavity 606, whereas the flow rate of the spray D1 is maintained as compared with the spray D4 because the gravity center axis 1203 has the long distance from the wall surface (top surface) of the piston 609 and the shear resistance is small. That is, the spray flow rate of the spray D1 is higher than that of the spray D4, so that a pressure difference is generated in the combustion chamber 107 of the engine to push up the air-fuel mixture 1201 formed in the cavity 606 by the first-time injection 1005 of the compression stroke 1003 in the direction of the negative electrode 612. As a result, even in the small injection amount, the air-fuel mixture richer than a theoretical air-fuel ratio can be formed around the negative electrode 612 and the positive electrode 613 (gap 617) of the ignition plug 604 at the ignition timing t107, and the ignition can stably be performed at the ignition timing retarded from the TDC.

The ECU 150 may perform the setting such that the total fuel injection amount of the first-time injection 1005 and the second-time injection 1006 in the compression stroke 1003 is smaller than the fuel injection amount of the first-time injection 1004 in the intake stroke 1002. In the intake stroke 1002, as compared with the compression stroke 1003, the geometric distance between the fuel injection device 101 and the piston 609 is long, and the tumble in the combustion chamber 107 is strong, so that the injected fuel flows easily, and hardly adheres to the cylinder wall surface 614 or the wall surface of the piston 609. On the other hand, in the compression stroke 1003, the injected fuel adheres easily to the piston 609 because the distance between the fuel injection device 101 and the piston 609 is small. Thus, by increasing the fuel injection amount in the intake stroke 1002 rather than the compression stroke 1003, the equivalence ratio in the combustion chamber 107 is easily set to the stoichiometric air-fuel ratio, and the fuel adhesion in the fuel injection in the compression stroke 1003 can be prevented to decrease HC and PN.

The ECU 150 sets the injection timing of the second-time injection 1006 in the compression stroke 1003 to the timing before the ignition timing t107 and before the TDC of the compression stroke 1003. When the differential pressure is generated in the combustion chamber 107 to raise the air-fuel mixture after the fuel injection, a time delay is generated due to the reach velocity of the spray and the delay of the opening of the valve body 214, so that the rich air-fuel mixture can be surely formed around the ignition plug 604 at the ignition timing t107 by setting the injection timing t106 of the second-time injection in the compression stroke 1003 (the injection immediately before the ignition timing t107). As a result, the combustion stability is improved, the ignition retard amount can be increased, and the effect that decreases HC associated with the early temperature rise (shortening of the warm-up time) of the catalyst 703 can be enhanced.

For example, the ignition retard amount in the catalyst warm-up period 1303 (see FIG. 13) may be set to, for example, 10 deg or more in an NA (natural intake) engine configuration with no supercharger, and the ignition retard amount may be set to 15 deg or more in an engine configuration with the supercharger 702. When the supercharger 702 exists, the mass of the exhaust system from the combustion chamber 107 to the catalyst 703 increases, it is necessary to increase the exhaust temperature higher than NA. In the configuration with the supercharger 702, for example, as an actual measurement value for clearing the exhaust regulations of SULEV (Super Ultra Low Emission Vehicle) 30 in North America, the ignition retard amount is set to 15 deg or more, which allows the temperature of the catalyst 703 to be certainly raised to decrease HC even if the mass of the exhaust system is increased.

The injection timing and the injection amount in the first-time injection 1005 and the second-time injection 1006 of the compression stroke 1003 may be decided such that the equivalence ratio around the electrode of the ignition plug 604 is higher than the average equivalence ratio in the combustion chamber 107 of the engine. When the equivalence ratio around the electrode of the ignition plug 604 is higher than the average equivalence ratio in the combustion chamber 107 of the engine, the air-fuel mixture can certainly be ignited, the combustion stability can be enhanced, and the ignition retard amount can be increased. As a result, the time until the temperature of the catalyst 703 is raised can be shortened, and the effect that decreases HC can be enhanced.

When the pressure of the fuel supplied to the fuel injection device 101, namely, the fuel pressure in the fuel piping 105 is high, the fuel injection amount of the second-time injection 1006 may be set smaller than the fuel injection amount in the first-time injection 1005 of the compression stroke 1003. Because the first-time injection 1005 of the compression stroke 1003 is performed in order to form the air-fuel mixture in the cavity 606, it is necessary to inject the fuel injection amount of a certain amount or more. On the other hand, the second-time injection 1006 of the compression stroke 1003 is performed in order to generate the differential pressure in the combustion chamber 107 of the engine. Thus, it is only necessary to ensure the flow rate of the spray in the second-time injection 1006 of the compression stroke 1003. For this reason, the fuel injection amount of the second-time injection 1006 of the compression stroke 1003 may be smaller than the fuel injection amount of the first-time injection 1005 of the compression stroke 1003. Even in this case, the equivalence ratio around the electrode of the ignition plug 604 can be increased. In the compression stroke 1003, the distance between the fuel injection device 101 and the piston 609 becomes closer as the piston 609 approaches the TDC, so that the injected spray adheres easily to the crown surface of the piston 609. Thus, the fuel injection amount is decreased in the injection (in this case, the second-time injection 1006) at the point of time the piston 609 approaches the TDC, which allows the fuel adhesion to the piston 609 to be prevented to obtain the effect that decreases PN and HC. At the ignition timing t107, when a plurality of regions where the equivalence ratio is high (fuel rich region) exist, PN increases. However, as described above, the fuel injection amount of the second-time injection 1006 in the compression stroke 1003 is controlled so as to be smaller than the fuel injection amount of the first-time injection 1005 in the compression stroke 1003, which allows the number of regions where the equivalence ratio is high to be decreased to enhance the effect that decreases PN.

In the compression stroke 1003, sometimes the penetration force of the spray decreases because the internal pressure of the combustion chamber 107 increases. For this reason, the injection timing of the second-time injection 1006 in the compression stroke 1003 may be set to the timing when the gravity center axis 1203 of the spray D1 is located closer to the ignition plug 604 side (upper side) in the stroke direction of the piston 609 than an exhaust piping-side end edge 1202 (see FIG. 12) of the cavity 606, and when an intersection 1205 of the extension axis 1207 of the gravity center axis 1204 of the spray D4 and the piston 609 is located in the cavity 606 in consideration of the delay time until the spray reaches the cavity 606. The spray formed by the first-time injection 1005 in the compression stroke 1003 can certainly be put into the cavity 606 by the setting of this injection timing.

Consequently, the equivalence ratio around the positive-side electrode 613 and the negative-side electrode 612 of the ignition plug 604 at the ignition timing t107 can be increased. As a result, even if the ignition timing t107 is retarded from the TDC, the combustion stability is improved, the temperature of the catalyst 703 can early be raised, and prevention of HC can early be performed.

Specifically, for example, the injection timing t105 of the first-time injection 1005 in the compression stroke 1003 may be set in the range of the crank angle of −100 to −40 deg (the crank angle ranging from −100 deg to −40 deg, both inclusive).

The timing when the tumble becomes the maximum before the TDC of the compression stroke is decided by an aspect ratio that is a ratio of the distance in the longitudinal direction (stroke direction) of the combustion chamber 107 of the engine and the distance in the radial direction. The distance in the radial direction is constant because it is decided by the outer diameter of the piston 609. When the piston 609 moves from BDC to TDC in the compression stroke 1003, the distance in the vertical direction becomes smaller to decrease the aspect ratio. As the aspect ratio decreases, the tumble and turbulent velocity start to increase from around timing till when the crank angle becomes −120 deg, and timing t112 when the turbulent velocity of the air becomes the maximum in the compression stroke 1003 comes near −40 deg before the TDC in the compression stroke 1003. The injection timing t106 in the second-time injection 1006 of the compression stroke 1003 may be set such that the injection period 1008 in the injection 1006 becomes the period in which the turbulent velocity decreases, namely, timing t112 when the turbulent velocity of the air in the compression stroke 1003 becomes the maximum, or after timing t112 (crank angle of −40 deg or later). In this way, when the second-time injection 1006 of the compression stroke 1003 is performed at the timing when the turbulent velocity decreases, the injected spray is hardly disturbed by the flow in the combustion chamber 107, so that the differential pressure in the combustion chamber 107 of the engine can certainly be formed to push up the air-fuel mixture 1201 in the direction of the ignition plug 604. As a result, the equivalence ratio around the positive-side electrode 613 and the negative-side electrode 612 of the ignition plug at the ignition timing t107 can be increased, the combustion can stably be continued under the ignition retard condition, the exhaust temperature can be increased, and the temperature of the catalyst 703 can early be raised. For this reason, HC in the exhaust gas can be decreased.

The ECU 150 may control the injection timing such that the injection timing t106 of the second-time injection 1006 (that is, the injection immediately before the ignition timing t107 of the ignition plug 604) of the compression stroke 1003 becomes the timing when the intersection 1205 of an extension axis 1207 of the gravity center axis 1204 of the spray D4 directed to at least the cavity 606 and the top surface of the piston 609 is located in the cavity 606 (that is, the timing when the intersection 1205 of the top surface of the piston 609 and the extension axis 1207 is located closer to the side of the fuel injection device 101 than the exhaust piping-side end edge 1202 of the cavity 606). As a result, the spray D4 can certainly be put into the cavity 606, and the flow rate of the spray D4 can be decreased to enhance the pressure of the side close to the piston 609, so that the vertical differential pressure can be generated in the combustion chamber 107 to push up the air-fuel mixture 1201 toward the ignition plug 604. The injection timing t106 of the second-time injection 1006 in the compression stroke 1003 may be set to the timing when an intersection 1206 of an extension axis 1208 of the gravity center axis 1203 of the spray D1 and the upper end face of the piston 609 is located closer to the side of the plug 604 than the cavity 606 in the stroke direction of the piston 609. The distance between the spray D1 and the upper end face of the piston 609 can be secured by the setting of this injection timing, and the decrease in the flow rate of the spray D1 can be prevented. As a result, the spray D1 on the side of the ignition plug 604 can be maintained at the high flow rate, the pressure around the ignition plug 604 is decreased to push up the air-fuel mixture 1201 in the direction of the ignition plug 604, and the equivalence ratio around the electrode of the ignition plug 604 can be increased at the ignition timing t107. As a result, the stable combustion can be performed in the state (ignition retard) in which the ignition timing is retarded (delayed angle) as compared with the TDC of the compression stroke 1003, the temperature of the catalyst 703 can early be raised, and HC can be decreased.

The control for warming up the catalyst 703 (catalyst warm-up) after the start of the engine will be described below.

FIG. 13 is a view illustrating a relationship between the elapsed time from start of the engine and the ignition retard amount, the fuel pressure, the fuel injection amount, and the engine speed of the first embodiment. The ignition retard amount of zero indicates that the ignition is performed at the position of the compression stroke TDC, the positive ignition retard amount indicates that the ignition is performed at the timing before the compression stroke TDC, and the negative ignition retard amount indicates that the ignition is performed at the timing later than the compression stroke TDC.

The ECU 150 performs the control for advancing the ignition retard amount with respect to the compression stroke TDC in a period 1301 from timing t31 when the engine is started to timing t32 when cranking performed until the combustion of the engine is stabilized is ended, which allows the stable combustion to be performed to raise the temperature in the combustion chamber 107 of the engine.

After timing t32 when the cranking is finished, the ECU 150 performs the control for decreasing the ignition retard amount to make the transition to the retard angle side, thereby increasing an exhaust loss to increase the temperature of the exhaust gas exhausted from the combustion chamber 107 of the engine to the exhaust port 608. As a result, the temperature of the catalyst 703 is early raised to activate the catalyst 703, and the effect that decreases HC using the catalyst 703 can early be obtained.

A transition region 1304 where the fuel pressure supplied to the fuel injection device 101 increases exists in a transition period 1302 from the cranking period 1301 to the transition to the ignition retard and the catalyst warm-up period 1303. This is attributed to the following fact. That is, because the fuel pump 106 that supplies the fuel to the fuel injection device 101 is configured to supply the fuel to the fuel piping 105 by a compression operation of a plunger synchronized with a camshaft of the engine. It takes a certain time for the fuel pressure to reach a predetermined target pressure 1305 in the state in which the engine speed is low. The transition region 1304 is generated between the timing t31 when the engine is started and timing t36 when the catalyst warm-up is ended.

Desirably the injection timing when the fuel is injected is changed because the penetration force of the sprays D1, D2, D3, D4, D5, D6 injected from the fuel injection device 101 is weakened when the fuel pressure is low. The fuel injection control in the low fuel pressure during catalyst warm-up (when the fuel pressure is lower than the target pressure 1305) will be described below.

FIG. 14 is a view illustrating the relationship between the crank angle and the injection timing when the fuel pressure is low during the catalyst warm-up in the first embodiment. In FIG. 14, the same component as that in FIG. 10 is designated by the same reference numeral.

The ECU 150 sets the injection timing of first-time injection 1405 (the injection two times before the ignition timing t107) in the compression stroke 1003 to injection timing t404 when the injection timing of the first-time injection 1405 is advanced by a period 1407 as compared with the injection timing t105 (see FIG. 10) when the fuel pressure is high. As described above, the injection timing is advanced, so that the air-fuel mixture can certainly be formed in the cavity 606 when the fuel pressure is low to weaken the penetration force of the spray, and when the reach time of the spray to the cavity 606 is lengthened. In the example of FIG. 14, the ECU 150 advances the injection timing by the certain amount when the fuel pressure by the sensor value from the pressure sensor 102 is lower than the target pressure 1305. Alternatively, for example, control may be performed such that the injection timing is advanced in a stepwise manner according to the fuel pressure by the sensor value from the pressure sensor 102.

The ECU 150 may also control the injection timing t405 of the second-time injection 1406 (the injection immediately before the ignition timing t107) in the compression stroke 1003 such that the injection timing t405 of the second-time injection 1406 is advanced earlier than the injection timing t106 of the high fuel pressure. The second-time injection is performed in order to generate the differential pressure in the combustion chamber 107 to push up the spray in the cavity 606. Although the timing of pushing up the spray does not depend on the fuel pressure, the penetration force of the spray decreases when the fuel pressure is low, and there is a possibility that the differential pressure in the combustion chamber 107 due to the second-time injection in the compression stroke 1003 decreases, or a possibility that the delay time from the fuel injection until the generation of the differential pressure is lengthened. On the other hand, as described above, when the fuel is injected at the low internal pressure of the combustion chamber 107 by increasing the timing of the second injection in the compression stroke 1003, the differential pressure can be generated at the timing close to the high fuel pressure, and the air-fuel mixture can be secured around the electrode of the ignition plug 604. A change amount of the first-time injection timing t405 at the low fuel pressure to the second-time injection timing t106 at the high fuel pressure may be set smaller than the change amount of the first-time injection timing t404 at the low fuel pressure to the first-time injection timing t105 at the high fuel pressure.

For example, when the fuel is injected once in the compression stroke as illustrated in FIG. 8, in order to increase the equivalence ratio of the air-fuel mixture around the electrode of the ignition plug 604, it is necessary to increase the fuel injection amount. However, as described above, when the fuel injection is divided into two times in the compression stroke, because the air-fuel mixture formed in the first-time injection of the compression stroke can be pushed up in the direction of the ignition plug 604 by the second-time injection, the fuel injection amount in the first-time injection of the compression stroke can be made smaller than the case of the single injection, and the fuel adhesion to the piston 609 can be prevented to decrease HC or PN discharged from the combustion chamber 107 through the exhaust port 608.

In the control of the injection timing in FIG. 14, the air-fuel mixture can stably be formed even at the low fuel pressure, and both the security of the air-fuel mixture around the electrode of the ignition plug 604 and the decrease of the fuel adhesion can be achieved at the same time. When the fuel pressure is greater than or equal to the predetermined target pressure 1305, the ECU 150 shifts the fuel injection control from the control in FIG. 14 to the control in FIG. 10.

For example, in the case of performing lean combustion in which the air-fuel ratio in the combustion chamber 107 is leaner than the ideal air-fuel ratio of 14.7:1, namely, the fuel is thinner, and in the case of forming the rich air-fuel mixture around the electrode of the ignition plug 604, as described above, the fuel injection may be controlled so as to be performed a plurality of times (for example, twice) in the compression stroke.

In order to stabilize the combustion in the engine during the catalyst warm-up, it is necessary to increase the turbulent velocity immediately before the ignition timing t107. When the injection is performed twice in the compression stroke, the ECU 150 may perform the control so as to close the valve 601 in the intake port 607, and cut off the air flow to the lower passage 611 of the intake port 607. In this way, the air in the direction that cancels the tumble in the combustion chamber 107 can be decreased, and the turbulent velocity in the combustion chamber 107 can be ensured.

The fuel injection control after the catalyst warm-up will be described below.

FIG. 24 is a view illustrating the relationship between the crank angle and the injection timing after the catalyst warm-up in the first embodiment.

At this point, for example, the ECU 150 can determine whether the catalyst warm-up is already ended based on the condition that the elapse time from the engine start exceeds a predetermined time or the condition that the temperature of the catalyst 703 exceeds a predetermined temperature.

In a period 1308 after the timing t36 when the catalyst warm-up period 1303 is ended, the ECU 150 performs the control for moving the ignition timing to ignition timing t257 on the advance side of TDC, and switches the control such that the fuel injection in the compression stroke 1003 is stopped to perform injection 2502 only in the intake stroke 1002.

Injection timing t252 of the injection 2502 in the intake stroke 1002 may be controlled so as to be advanced earlier than the injection timing t102 (see FIG. 10) of the intake stroke 1002 in the catalyst warm-up period 1303. For example, the injection timing t252 of the intake stroke 1002 may be controlled so as to be advanced earlier than the timing t110 when the tumble becomes the maximum, for example, the timing near the crank angle of −300 to −280 deg. After the catalyst warm-up period 1303 is ended, because the temperature of the piston 609 and the cylinder wall surface 614 is increased, even if the fuel adheres, the fuel is easy to vaporize, and HC and PN are hardly generated. When the injection timing t257 is advanced, the injected spray can easily float on the flow to improve the homogeneity, so that the effect that decreases NOx can be obtained. As described above, when the fuel injection control is switched after the catalyst warm-up is ended, the temperature of the catalyst 703 can certainly be raised in the catalyst warm-up period 1303 to decrease HC, and NOx can be decreased after the catalyst warm-up period 1303 is ended.

A method for setting the target pressure during the catalyst warm-up will be described below.

FIG. 20 is a view illustrating the relationship between the fuel pressure and a particle size of the fuel injected from the fuel injection device. In FIG. 20, a solid line 2001 indicates Dv90, a broken line 2002 indicates the Sauter mean diameter D32, and an alternate long and short dash line 2003 indicates the ratio of Dv90 and D32. The Dv90 is the particle size when the particle amount reaches 90% in a distribution of the particle size and a particle amount in the injected fuel.

The large Dv90 indicates that many coarse particles having the large particle sizes exist as fuel particles, the fuel particles are hardly evaporated, and the fuel adheres easily to the cylinder wall surface 614 and the piston 609. The small Dv90 indicates that the fuel hardly adheres to the cylinder wall surface 614 and the piston 609.

As illustrated by the solid line 2001 in FIG. 20, Dv90 has an inflection point 2004 where the change in Dv90 changes exists as the fuel pressure increases. On the other hand, as illustrated by the broken line 2002 in FIG. 20, the point where the change in the Sauter mean diameter D32 changes does not exist even if the fuel pressure increases.

For example, a fuel pressure 2005 at the inflection point 2004 of the Dv90 may be set as the target pressure 1305 (see FIG. 13) during the catalyst warm-up. In the first embodiment, for example, the fuel pressure 2005 at the inflection point 2004 ranges from about 10 MPa to about 15 MPa, so that the target pressure 1305 during the catalyst warm-up may be set greater than or equal to 10 MPa.

The target pressure 1305 is decided in this way, and whether the fuel pressure is greater than or equal to the target pressure 1305 is determined. Consequently, whether the spray injected from the fuel injection device 101 adheres easily to the cylinder wall surface 614 or the piston 609 can appropriately be determined, and the fuel injection control suitable for that state can be performed.

An engine system according to a second embodiment will be described below. A difference from the engine system of the first embodiment will mainly be described with reference to the drawings in the engine system of the first embodiment as appropriate.

FIG. 15 is a view illustrating temporal changes in the injection pulse, the drive voltage, the drive current, and the valve body displacement amount for driving the fuel injection device of the second embodiment.

The ECU 150 of the second embodiment controls a displacement amount of the valve body 214 of the fuel injection device 101 while switching the displacement amount between a maximum height position 1503 and a low height position 1505 lower than the maximum height position 1503, which allows the adjustment of the fuel injection amount injected from the fuel injection device 101. When the displacement amount of the valve body 214 is set to the low height position 1505, the ECU 150 performs the control so as to shorten the pulse width as indicated by the injection pulse 1504. In this case, the drive voltage and the drive current output from the drive circuit 103 are changed as indicated by the alternate long and short dash line, and the displacement of the valve body is changed as indicated by the line 1501.

In the second embodiment, the ECU 150 performs the control such that the height position of the valve body 214 of the fuel injection device 101 in at least one of the second-time injection 1006 (the injection immediately before the ignition timing t107) of the compression stroke 1003 in FIG. and the first-time injection 1005 (two times before the ignition timing t107) of the compression stroke 1003 is set to the low height position 1505 lower than the maximum height position 1503.

In the injection 1006 close to the ignition timing t107, because of the short distance between the fuel injection device 101 and the piston 609, the injected fuel adheres easily to the piston 609 as compared with the intake stroke 1002. When the fuel pressure is high, atomization is promoted, and the fuel hardly adheres to the piston 609. On the other hand, because the spray flow rate increases, the penetration force of the spray increases, and the fuel adheres easily. As a result, there is a possibility that the amount of fuel adhering to piston 609 increases.

In the second embodiment, the ECU 150 performs the control such that the displacement (height position) of the valve body 214 becomes the low height position 1505 lower than the maximum height position 1503 in the injection 1006 immediately before the ignition timing t107, such that the pulse width is decreased as indicated by the injection pulse 1504. The height position of the valve body 214 is set to the low height position 1505 lower than the maximum height position 1503, and the sectional area of the passage through which the fuel passes between the valve body 214 and the valve seat 218 is reduced. Consequently, a pressure drop of the fuel passing through the passage can intentionally be generated, and the spray flow rate can be decreased. As a result, the fuel adhesion to the piston 609 and the like in the compression stroke 1003 can be prevented, and generated HC and PN can be decreased.

The ECU 150 may perform the control such that the height position of the valve body 214 becomes the low height position 1505 lower than the maximum height position 1503 in the first-time injection 1005 (the injection 1005 two times before the ignition timing t107) of the compression stroke 1003. As a result, the fuel adhesion to the piston 609 and the like in the first-time injection 1005 of the compression stroke 1003 can be prevented, and generated HC and PN can be decreased.

In the second embodiment, in the injection 1006 immediately before the ignition timing t107, because the turbulent velocity of the air in the combustion chamber 107 of the engine is large, when the spray floats on the flow and the fuel does not adhere to the piston 609, or as illustrated in the first embodiment, when the flow rate of the sprays D3, D4, D5 directed to the piston 609 is smaller than that of the sprays D1, D2, D6 in the fuel injection device 101, sometimes the fuel does not adhere to the piston 609 even if the fuel is injected in the compression stroke 1003 at the high fuel pressure. In such cases, the ECU 150 controls the injection pulse width such that the height position of the valve body 214 becomes the maximum height position 1503 in the injection 1006 immediately before the ignition timing t107, and the ECU 150 controls the injection pulse width such that the height position of the valve body 214 becomes the low height position 1505 in the injection 1005 two times before the ignition timing t107 when the turbulent velocity is weakened.

When the fuel pressure is low, the ECU 150 may perform the control such that the height position of the valve body 214 of the fuel injection device 101 in at least one of second-time injection 1406 (the injection immediately before the ignition timing t107) of the compression stroke 1003 in FIG. 14 and first-time injection 1405 (two times before the ignition timing t107) of the compression stroke 1003 is set to the low height position 1505 lower than the maximum height position 1503. Because the flow rate of the fuel spray injected from the fuel injection device 101 decreases when the fuel pressure is low, sometimes the fuel hardly adheres to the piston 609 even if the height position of the valve body 214 in the injection (1405, 1406) of the compression stroke 1003 is moved to the maximum height position 1503. In such cases, in order to promote the atomization of the spray, the ECU 150 may perform the control such that the injection pulse width so that the height position of the valve body 214 in the injection (1405, 1406) of the compression stroke 1003 is set to the maximum height position 1503. In this way, when the fuel pressure is low, the fuel adhesion can be prevented, and PN and HC can be decreased.

The control method performed by the ECU 150 of the second embodiment may appropriately be combined with the control method performed by the ECU 150 in the first embodiment and third to fifth embodiments (to be described later).

An engine system according to a third embodiment will be described below. A difference from the engine system of the first embodiment will mainly be described with reference to the drawings in the engine system of the first embodiment as appropriate.

FIG. 16 is a view illustrating the relationship between the crank angle and the injection timing when the fuel pressure is low in a third embodiment.

In the third embodiment, the ECU 150 changes the split ratio of the first embodiment between the fuel injection amount in the first-time injection in the compression stroke 1003 and the fuel injection amount in the second-time injection according to the fuel pressure.

When the fuel pressure is low, as compared with the case where the fuel pressure is high (for example, when the injection control in FIG. 10 is performed), the ECU 150 performs the setting so as to increase the ratio of the fuel injection amount in the second-time injection (the injection immediately before the ignition timing t107) in the compression stroke 1003 to the fuel injection amount in the first-time injection (two times before the ignition timing t107) in the compression stroke 1003. That is, ECU 150 performs the setting such that the ratio of the fuel injection amount of injection 1606 to the fuel injection amount of injection 1605 in FIG. 16 is higher than the ratio of the fuel injection amount of the injection 1006 to the fuel injection amount of the injection 1005 in FIG. 10.

Because the penetration force of the spray is decreased when the fuel pressure is low, the differential pressure generated in the combustion chamber 107 of the engine is decreased when the fuel injection amount of the second-time injection 1606 in the compression stroke 1003 is decreased, and the air-fuel mixture formed by the first-time injection 1605 in the compression stroke 1003 is hardly pushed up in the direction of the ignition plug 604. On the other hand, in the third embodiment, when the ratio of the fuel injection amount of the second-time injection 1606 in the compression stroke 1003 to the fuel injection amount of the first-time injection 1605 in the compression stroke 1003 is increased larger than the ratio of the fuel injection amount of the injection 1006 to the fuel injection amount of the injection 1005 at the high fuel pressure, the penetration force of the spray can be secured, the differential pressure can be increased, and the equivalence ratio of the air-fuel mixture around the electrode of the ignition plug 604 at the ignition timing t107 can be increased. As a result, the combustion is stabilized even if the ignition is retarded, so that the temperature of the catalyst 703 can early be raised to decrease the generated HC.

When it is necessary to increase the fuel injection amount in the second-time injection 1606 in the compression stroke 1003, the fuel injection amount in the injection 1604 in the intake stroke 1002 may be decreased. HC and PN can be decreased because the injected fuel hardly adheres to the cylinder wall surface 614 by decreasing the fuel injection amount in the injection 1604.

An engine system according to a fourth embodiment will be described below. A difference from the engine system of the first embodiment will mainly be described with reference to the drawings in the engine system of the first embodiment as appropriate.

FIG. 17 is a view illustrating the relationship between the engine speed and the equivalence ratio of the air-fuel mixture around the ignition plug. In FIG. 17, the theoretical air-fuel ratio of an equivalence ratio of 1 is indicated by a line 1702, and the target equivalence ratio during the catalyst warm-up is indicated by a line 1704.

As illustrated in FIG. 13, a rotation velocity transition period 1306 in which the engine speed changes exists from the engine start to the catalyst warm-up period 1303, and the equivalence ratio the air-fuel mixture around the electrode of the ignition plug 604 varies when the engine speed changes.

For example, when the injection timing and the fuel injection amount in the compression stroke are the same as the case of the high fuel pressure, the relationship between the engine speed and the equivalence ratio of the air-fuel mixture around the electrode of the ignition plug 604 is illustrated by a line 1701. That is, the equivalence ratio of the air-fuel mixture around the electrode of the ignition plug 604 can be maintained at a value close to the target equivalence ratio indicated by a line 1704 for the high engine speed (in the case close to a target rotation velocity 1705 (corresponding to a target system point 1307 in FIG. 13)), whereas the equivalence ratio of the air-fuel mixture around the electrode of the ignition plug 604 is decreased lower than the equivalence ratio of 1 indicated by a line 1702 for the low engine speed as indicated by a point 1706.

An equivalence ratio distribution in the combustion chamber 107 of the engine for the engine speed corresponding to the point 1706 will be described below.

FIG. 18 is a view illustrating the distribution of the equivalence ratio of the air-fuel mixture in the combustion chamber of the engine at the point of time of each crank angle. FIGS. 18(a), 18(b), and 18(c) illustrate contour lines of the equivalence ratio at the respective crank angles of −55 deg, −30 deg, and +20 deg at the point 1706 in FIG. 17. In FIG. 18, the numerical value of the equivalence ratio is displayed on each contour line. The fuel injection timing is set to the first-time injection timing t105 (−60 deg) of the compression stroke 1003 in FIG. 10.

For the crank angle of −55 deg, as illustrated in FIG. 18(a), an air-fuel mixture cloud 1801 that is a fuel rich region gets over the exhaust piping-side end edge 1202 of the cavity 606, and the air-fuel mixture is not held in the cavity 606. This is because when the first-time injection timing of the compression stroke 1003 is set to the same injection timing as the case of the high rotation velocity, the engine speed is slow, the velocity at which the piston 609 rises is slow, and the spray gets over the exhaust piping-side end edge 1202.

In the fourth embodiment, even if the engine speed is low, in order to maintain the high equivalence ratio of the air-fuel mixture around the electrode of the ignition plug 604, the ECU 150 performs the control so as to delay the first-time injection timing in the compression stroke 1003 as compared with the case of the high engine speed.

As described above, in the ECU 150 of the fourth embodiment, when the engine speed is low, the first-time injection timing of the compression stroke is decreased slower than the case of the high engine speed. Consequently, as indicated by a point 1707 in FIG. 17, the equivalence ratio of the air-fuel mixture around the electrode of the ignition plug 604 can be increased, the ignition can certainly be performed using the ignition plug 604, and the combustion can also be stabilized with the ignition retard even in the period in which the engine speed varies. For this reason, the temperature of the catalyst 703 can early be raised to decrease HC and NOx.

In the fourth embodiment, the target value of the equivalence ratio of the air-fuel mixture around the electrode of the ignition plug 604 during the catalyst warm-up may be set to a value larger than 1. When the ignition retard is performed, because the piston 609 performs the ignition in the expansion stroke between the TDC and the BDC, the turbulent velocity is decreased, the combustion velocity is decreased, and there is a possibility that the combustion becomes unstable. However, the equivalence ratio of the air-fuel mixture around the electrode of the ignition plug 604 is set to the value larger than 1, namely, the fuel is set richer than the stoichiometric air-fuel ratio, which allows the combustion range to be secured to effectively stabilize the combustion. In this way, even if the ignition retard is performed, the combustion can be stabilized, the temperature of the catalyst 703 can be certainly raised, and HC can be decreased.

The control of the ECU 150 of the fourth embodiment may be combined with the control of the ECU 150 of the first to third embodiments.

An engine system according to a fifth embodiment will be described below. A difference from the engine system of the first embodiment will mainly be described with reference to the drawings in the engine system of the first embodiment as appropriate.

FIG. 19 is a view illustrating the relationship between the elapsed time from the start of the engine and the amount of the ignition retard, the intake pressure, the fuel pressure, the fuel injection amount, and the engine speed in the fifth embodiment.

The ECU 150 of the fifth embodiment performs the control for operating the supercharger 702 to perform the supercharging after engine start such that the intake pressure of the intake port 607 is larger than an atmospheric pressure 1901 in the catalyst warm-up period 1303.

Because the air pressure in the intake port 607 increases by performing such control, the amount of air flowing into the combustion chamber 107 of the engine increases to increase exhaust enthalpy, and the temperature of the catalyst 703 can early be raised. As a result, HC and PN can be decreased. The exhaust heat raises the intake air temperature due to supercharging of the supercharger 702, and the temperature of the engine system is raised, so that heat exchange efficiency in which the engine system converts a heat amount of the supplied fuel into the temperature rises. Thus, even if the fuel injection amount is the same, a total heat amount increases in performing the conversion into the illustrated work, a cooling loss, and an exhaust loss, the temperature of the catalyst 703 can early be raised, and HC and PN can be decreased.

Immediately after the engine start, the temperature of the engine system is low and the engine speed is low, so that the compressor 702A of the supercharger 702 is hardly rotated. On the other hand, the ECU 150 may set the timing t191 when the compressor 702A is rotated to after the cranking period 1301 is ended. When the ignition timing is advanced from 0 deg, sometimes the engine output increases excessively when the supercharging is performed by the supercharger 702. For this reason, the timing of rotating the compressor 702A may be delayed later than the point of time the ignition timing is delayed after the end of the transition period 1302 in which the transition to the ignition retard is made. When the timing t191 of rotating the compressor 702A is set as described above, the temperature of the catalyst 703 can certainly and early be raised, and the effect that decreases HC can be enhanced.

The control of the ECU 150 of the fifth embodiment may be combined with the control of the ECU 150 of the first to fourth embodiments.

An engine system according to a sixth embodiment will be described below. A difference from the engine system of the first embodiment will mainly be described with reference to the drawings in the engine system of the first embodiment as appropriate.

FIG. 21 is a view illustrating the relationship between the crank angle and the injection timing in the sixth embodiment.

In the sixth embodiment, the fuel injection in the first embodiment of the compression stroke 1003 when the fuel pressure is high during the catalyst warm-up is divided into three times.

In the sixth embodiment, the ECU 150 performs the controls so as to perform injection 2101, injection 2102, and injection 2103 in the compression stroke 1003. Injection timing t211 of the injection 2101 may be the same timing as the injection timing t105 of the first-time injection 1005 in the compression stroke 1003 in FIG. 10, or the injection timing t213 of the injection 2103 (the injection immediately before the ignition timing t107) may be the same timing as the injection timing t106 of the second-time injection 1006 in the compression stroke 1003 in FIG. 10. In the sixth embodiment, the ECU 150 performs the injection while dividing the fuel injection amount of the injection 1005 in FIG. 10 into the injection 2101 and the injection 2102.

In the injection of the compression stroke 1003, because the geometric distance between the fuel injection device 101 and the piston 609 is shorter than that of the intake stroke 1002, the injected fuel adheres easily to the piston 609. Thus, the fuel injection amount per injection can be suppressed by dividing the injection forming the air-fuel mixture in the cavity 606 into not only the injection 1005 but also the injection 2101 and the injection 2102, so that the effect that decreases the penetration force of the spray is obtained. As a result, the fuel adhesion to the piston 609 can be prevented to decrease PN.

Because the distance between the cavity 606 and the fuel injection device 101 is shortened by providing the injection 2102, the spray easily enters the cavity 606 and the air-fuel mixture is easily formed in the cavity 606. Consequently, the rich air-fuel mixture can stably be formed around the electrode of the ignition plug 604 by the injection 2103 immediately before the ignition timing t107, and the combustion stability can be enhanced. As a result, the ignition retard can be increased, the temperature of the catalyst 703 can early be raised, and the effect that decreases HC can be enhanced.

The control of the second embodiment in which the valve body 214 is driven at the low height position lower than the maximum height position in the first-time injection 2101 in the compression stroke 1003 and the second-time injection 2102 in the compression stroke 1003 may be combined. Consequently, because the penetration force of the spray can be decreased, the fuel adhesion to the piston 609 can be further decreased, and PN can further be prevented.

Although the fuel injection in the compression stroke 1003 is performed by dividing the fuel injection into three times, the fuel injection may be divided into at least four times. By way of example, the fuel injection is divided when the fuel pressure during the catalyst warm-up is higher than the target pressure. Alternatively, when the fuel pressure during the catalyst warm-up is lower than the target pressure, the fuel injection in the compression stroke 1003 may be divided into at least three times.

The present invention is not limited to the above embodiments, but the changes can suitably be made without departing from the scope of the present invention.

For example, a part or all of the pieces of processing performed by the ECU 150 in the above embodiments may be performed by the CPU 104 or a hardware circuit different from the CPU 104. A part of the pieces of processing performed by the drive circuit 103 may be performed by the CPU 104.

### REFERENCE SIGNS LIST

100 engine system
101 fuel injection device
102 pressure sensor
103 drive circuit
104 CPU
107 combustion chamber
108 cylinder
150 ECU
606 cavity
607 intake port
609 piston
604 ignition plug
612 negative electrode
613 positive electrode

1. A fuel injection control device that controls a fuel injection device installed in a combustion chamber of an internal-combustion engine so as to be able to inject fuel in a direction intersecting with a sliding direction of a piston, the fuel injection control device comprising:
an acquisition unit that acquires a pressure value of the fuel supplied to the fuel injection device; and
an injection controller that performs control such that the fuel injection device injects the fuel at least twice in a compression stroke,
wherein the injection controller performs control such that fuel injection timing of at least one time in the compression stroke is advanced earlier than fuel injection timing of a time corresponding to the high pressure value of the fuel when the fuel pressure value acquired by the acquisition unit is low.

2. The fuel injection control device according to claim 1, wherein the injection controller performs control such that the fuel injection timing of all times in the compression stroke is advanced earlier than the fuel injection timing of the time corresponding to the high pressure value of the fuel when the fuel pressure value acquired by the acquisition unit is low.

3. The fuel injection control device according to claim 2, wherein the injection controller performs control such that a change amount of the fuel injection timing of a last time in the compression stroke is smaller than a change amount of the fuel injection timing of a previous time.

4. The fuel injection control device according to claim 1, wherein the injection controller performs control such that the high pressure value of the fuel is smaller than the low pressure value of the fuel in a ratio of an injection amount in fuel injection of the last time to an injection amount in fuel injection of a time before the last time in the compression stroke.

5. The fuel injection control device according to claim 1, further comprising an ignition controller that controls ignition timing of an ignition plug that ignites the fuel in the combustion chamber to timing retarded later than a top dead center of the compression stroke when a predetermined condition that warms up a catalyst is satisfied, the catalyst that purifies exhaust being disposed on an exhaust downstream side of the internal-combustion engine.

6. The fuel injection control device according to claim 5, wherein the ignition controller controls the ignition timing of the ignition plug to timing before the top dead center of the compression stroke when the predetermined condition that warms up the catalyst is not satisfied.

7. The fuel injection control device according to claim 1, further comprising a rotation velocity acquisition unit that acquires a rotation velocity of the internal-combustion engine,
wherein the injection controller performs control such that the fuel injection timing of all times in the compression stroke is delayed as compared with the high rotation velocity of the internal-combustion engine when the rotation velocity of the internal-combustion engine is low.

8. The fuel injection control device according to claim 1, wherein
a cavity is formed on a combustion chamber side in the piston,
a first fuel injection hole facing a side of the ignition plug that ignites the fuel in the combustion chamber and a second fuel injection hole facing the cavity side are made in the fuel injection device, and
the injection controller sets timing when an extension axis of a gravity center of a fuel spray injected from the second fuel injection hole intersects with the cavity to the fuel injection timing of a time immediately before the ignition timing of the ignition plug.

9. The fuel injection control device according to claim 8, wherein
the fuel injection device is disposed on an intake port side of the combustion chamber, and
the cavity of the piston is formed in a range from the side close to the intake port to a position corresponding to a sliding direction of the piston at an ignition position between positive and negative electrodes of the ignition plug in a surface on a combustion chamber side of the piston.

10. The fuel injection control device according to claim 1, further comprising an intake controller that closes the valve when control for injecting the fuel is performed at least twice in the compression stroke,
wherein the intake port is connected to the combustion chamber in order to supply air, and
the intake port includes a partition wall that divides an inside of the intake port into a first passage through which air flows to a circumferential edge side of the combustion chamber and a second passage through which air flows to a center of the combustion chamber and a valve that cuts off an air flow to the first passage.

11. The fuel injection control device according to claim 1, wherein an air-fuel mixture of air and fuel around the ignition plug at ignition timing of the ignition plug that ignites the fuel in the combustion chamber is greater than an average equivalence ratio in the combustion chamber.

12. The fuel injection control device according to claim 1, wherein
the catalyst that purifies the exhaust is disposed on the exhaust downstream side of the internal-combustion engine, and
the injection controller performs control for injecting the fuel at least twice in the compression stroke when the predetermined condition that warms up the catalyst is satisfied, and performs control for not injecting the fuel in the compression stroke when the predetermined condition that warms up the catalyst is not satisfied.

13. The fuel injection control device according to claim 1, wherein
the fuel injection device includes a valve body, a valve seat including a seat surface on which the valve body is seated, a needle that drives the valve body, and a coil through which a drive current passes to drive the needle, and
the injection controller controls a movement amount of the valve body to a movement amount smaller than a maximum movement amount in the fuel injection of at least one time in the compression stroke.

14. The fuel injection control device according to claim 1, wherein
the catalyst that purifies the exhaust is disposed on the exhaust downstream side of the internal-combustion engine, and
the injection controller performs control such that the fuel injection of at least one time is performed in the intake stroke, and performs control such that injection timing of the intake stroke is advanced when the predetermined condition that warms up the catalyst is not satisfied, as compared with a case where the predetermined condition that warms up the catalyst is satisfied.

15. The fuel injection control device according to claim 1, further comprising a supercharging controller that operates a supercharger such that an intake pressure of the internal-combustion engine is increased higher than an atmospheric pressure when the predetermined condition that warms up the catalyst is satisfied,
wherein the catalyst that purifies the exhaust and the supercharger that increases an amount of air taken in by the internal-combustion engine by power of the exhaust are disposed on the exhaust downstream side of the internal-combustion engine.
